(19) United States
(12) Patent Application Publication
(10) Pub. No.: US 2015/0233846 A1
(43) Pub. Date: Aug. 20, 2015

(54) SYSTEM AND METHOD FOR IDENTIFYING HYDROCARBON POTENTIAL IN A ROCK FORMATION USING X-RAY FLUORESCENCE

(71) Applicants: Robert E. Locklair, Houston, TX (US); Autumn Eakin, Houston, TX (US); Trevor V. Howald, Houston, TX (US); Brendan K. Horton, Houston, TX (US); Jozina Dirkzwager, Houston, TX (US)

(72) Inventors: Robert E. Locklair, Houston, TX (US); Autumn Eakin, Houston, TX (US); Trevor V. Howald, Houston, TX (US); Brendan K. Horton, Houston, TX (US); Jozina Dirkzwager, Houston, TX (US)

(73) Assignee: Chevron U.S.A. Inc., San Ramon, CA (US)

(21) Appl. No.: 14/620,701

(22) Filed: Feb. 12, 2015

Related U.S. Application Data
(60) Provisional application No. 61/940,053, filed on Feb. 14, 2014.

(51) Int. Cl. G01N 23/223

(52) U.S. Cl. CPC G01N 23/223

(57) ABSTRACT

A system and a method for identifying a hydrocarbon sweet spot in a rock formation are disclosed. The method includes collecting a dataset comprising an elemental composition of one or more rock samples at various depths or locations, using an x-ray fluorescence device; analyzing the collected dataset of the one or more rock samples including analyzing the elemental composition of the one or more rock samples; establishing a time-correlative sample framework based on the collected dataset regarding the elemental composition of the one or more rock samples; performing a map-based spatial analysis comprising creating a distribution of concentration of one or more elements in the one or more rock samples in a geographical map generated within the framework; and identifying one or more locations of accumulation of hydrocarbons using the map-based spatial analysis.

### CROSS-REFERENCE TO RELATED APPLICATIONS

The present application claims priority to U.S. Provisional Application No. 61/940,053 filed on Feb. 14, 2014, the entire content of which is incorporated herein by reference.

### FIELD

The present invention relates to a system and method for identifying hydrocarbon potential in a rock formation using x-ray fluorescence in addition to geochemical and structural information.

### BACKGROUND

Rocks, via outcrop, core, plugs, drilling chips, or other, can be analyzed by geochemical processes to determine the geochemistry and hydrocarbon potential for rock formations or units of interest. Traditional methods employ the use of Inductively Coupled Plasma Mass Spectrometry (ICP-MS), X-ray Diffraction (XRD), and TOC-analyzer in determining elemental concentrations, mineral identification and quantification, and measurement of total organic carbon (TOC), respectively. These methods are often destructive of the original rock/sample and are time consuming and expensive for complete formation/unit of interest characterization.

A more recent method in rock characterization is based on hand held X-ray fluorescence (HHXRF), which allows for quick, cost effective, and nondestructive measurements of rocks/samples (Tribovillard, N., Algeo, T., Lyons, T., Riboulleau, A., 2006, “Trace metals as paleo-redox and paleo-productivity proxies: An update.” Chemical Geology, Volume 232, 12-32) describes the use of X-ray fluorescence (XRF) measurements as possible “proxies for paleo-productivity and paleo-redox conditions.” Element concentrations of molybdenum (Mo), vanadium (V), and uranium (U) can be used to infer anoxic-euxinic conditions, or lack thereof. Ratcliffe and Wright (Ratcliffe, K., Wright, M., 2012a, “Unconventional methods for unconventional plays: Using elemental measurements to understand shale resource plays, Part I.” PESA News Resources, February/March, 89-93) discussed the use of XRF and ICP-MS measurements for detailed correlation of units, members, etc. between wells in the Haynesville Formation. The elemental measurements allowed for detailed chemostratigraphy that was above the resolution of traditional gamma logs. A second publication from Ratcliffe and Wright (Ratcliffe, K., Wright, M., 2012b, “Unconventional methods for unconventional plays: Using elemental measurements to understand shale resource plays, Part II.” PESA News Resources, February/March, 55-60) goes into more detail on methods that can be used in unconventional play characterization. Cross plots of various elemental concentrations or ratios were shown to differentiate terrigenous input from authigenic processes. The authors also mentioned that regression lines can be made from cross plots of elemental measurements and XRD mineral abundances to infer mineral abundances where only XRF measurements were collected.

However, at the present time, there are no methods or systems for identifying hydrocarbon potential in a rock formation or an oil or gas reservoir using XRF-based maps, as will be described in the following paragraphs.

### SUMMARY

An aspect of the present invention is to provide a method for identifying a hydrocarbon sweet spot in a rock formation. The method includes collecting a dataset comprising an elemental composition of one or more rock samples at a plurality of depths or locations, using an x-ray fluorescence device; analyzing the collected dataset of the one or more rock samples including analyzing the elemental composition of the one or more rock samples; establishing a time-correlative sample framework based on the collected dataset regarding the elemental composition of the one or more rock samples; performing a map-based spatial analysis comprising creating a distribution of concentration of one or more elements in the one or more rock samples in a geographical map generated within the framework; and identifying one or more locations of accumulation of hydrocarbons using the map-based spatial analysis.

Another aspect of the present invention is to provide a system for identifying a hydrocarbon sweet spot in a rock formation. The system includes an x-ray fluorescence (XRF) device configured to acquire XRF data from a rock sample. The system also includes a storage device configured to store a dataset comprising an elemental composition of one or more rock samples at a plurality of depths or locations, the dataset being collected using the XRF device. The system further includes one or more computer processor units configured to: 1) analyze the collected dataset of the one or more rock samples including analyzing the elemental composition of the one or more rock samples; 2) establish a time-correlative sample framework based on the collected dataset regarding the elemental composition of the one or more rock samples; 3) perform map-based spatial analysis comprising creating a distribution of concentration of one or more elements in the one or more rock samples in a geographical map generated within the framework; and 4) identify one or more locations of accumulation of hydrocarbons using the map-based analysis.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various Figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a scatter plot with a plurality (e.g., four) different variables analyzed, according to an embodiment of the present invention;

FIG. 2 depicts an example of map-based spatial analysis, according to the embodiment of the present invention;

FIG. 3. shows an example of sweet spot identification, according the embodiment of the present invention;

FIG. 4 shows depositional characteristics within a framework, according to an embodiment of the present invention;

FIG. 5 is a flow chart of a method of identifying hydrocarbon potential in a rock formation, according to an embodiment of the present invention;

FIG. 6 is another flow chart of the method of identifying hydrocarbon potential in a rock formation, according to an embodiment of the present invention; and

FIG. 7 is a schematic diagram representing a computer system for implementing the method, according to an embodiment of the present invention.

### DETAILED DESCRIPTION

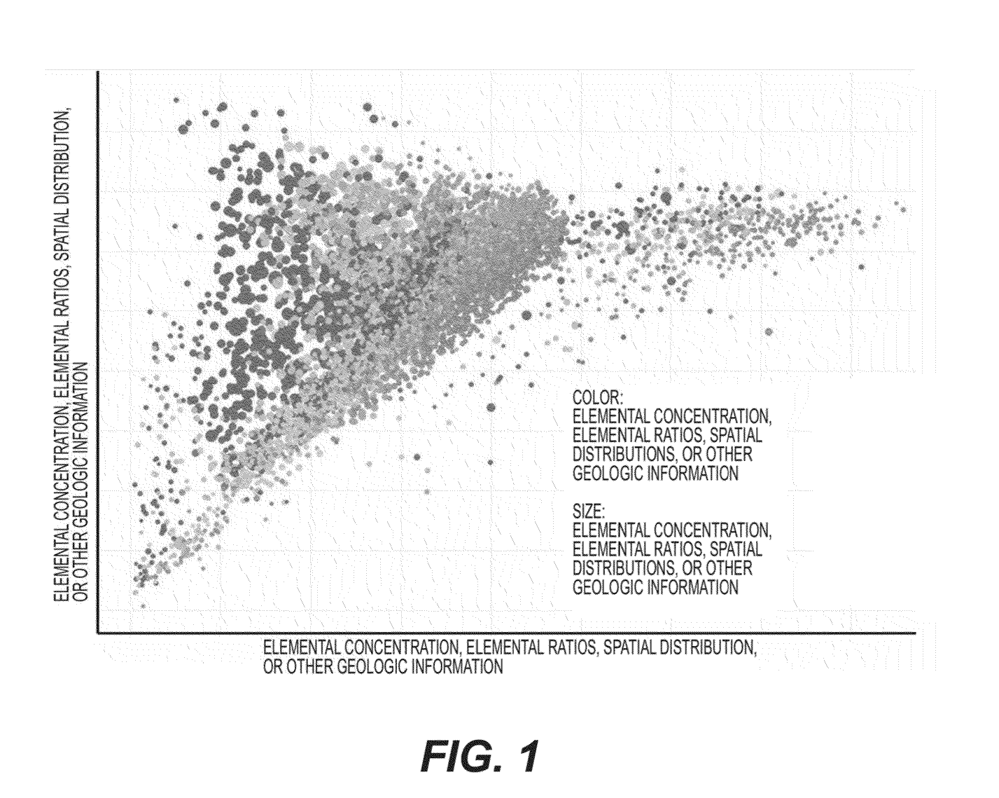

FIG. 1 depicts a cross plot showing a typical four dimensional (4D) variable analysis. The plot area is represented in 2D geometric space with the x and y axes containing elemental concentrations in parts per million (ppm) or weight percent, elemental ratios, or other spatial and/or framework geologic variables. The information or data shown in the x-y space can be further classified. Examples include color-coding and/or size scaling, to interpret the elemental (e.g., Mo, V, Al, etc.) or geologic information (e.g., depth, age, geographical location, depositional sequence, TOC, mineralogy, etc.) within the context of the framework or spatial distribution. Color, shape, and size of the data point (dots, in this example) may be used to further characterize the rock. The color, shape, or size can be varied by depth, formation, elemental concentrations, TOC, or any other geologic variable (previously mentioned) that can be interpreted within, or used to define, the context of the framework or spatial distribution. In this example, the color of the sample measurement is varied to reflect the formation from which each measurement is collected. The size of the measurement points may also be varied to highlight another geologic aspect relevant to the characterization (i.e. depth, formation, elemental abundances, TOC, etc. . . . ). Therefore, in this example, the location of each dot represents the relationship between the concentration of element A (x-axis) and the concentration of element B (y-axis). The color of the dot distinguishes one sample suite of one formation from another, and the size varies with depth. In addition, a fourth dimension for analysis can be introduced with a filtering method to some threshold value of a fourth element, fourth elemental ratio, or other fourth geologic variable.

4D analysis can be used for understanding elemental relationships within the context of the established framework. Furthermore, the type of cross plot analysis shown in FIG. 1 allows for quality control when defining the framework of interest. From this phase in the presented workflow, information regarding the sedimentary system and paleo-environmental indicators can be used. Examples include present-day sediment composition (biogenic, detrital-siliciclastic, authigenic, etc. . . . ), indicators for early and late diagenesis, indicators of paleo-redox conditions, etc. . . . . This type of analysis also lends itself to statistical quantification of select variables and their distribution patterns spatially and with increasing depth. Having an established framework constrains time intervals for key periods of sediment deposition, therefore, a quantitative analysis allows for interpretation of accumulation with time.

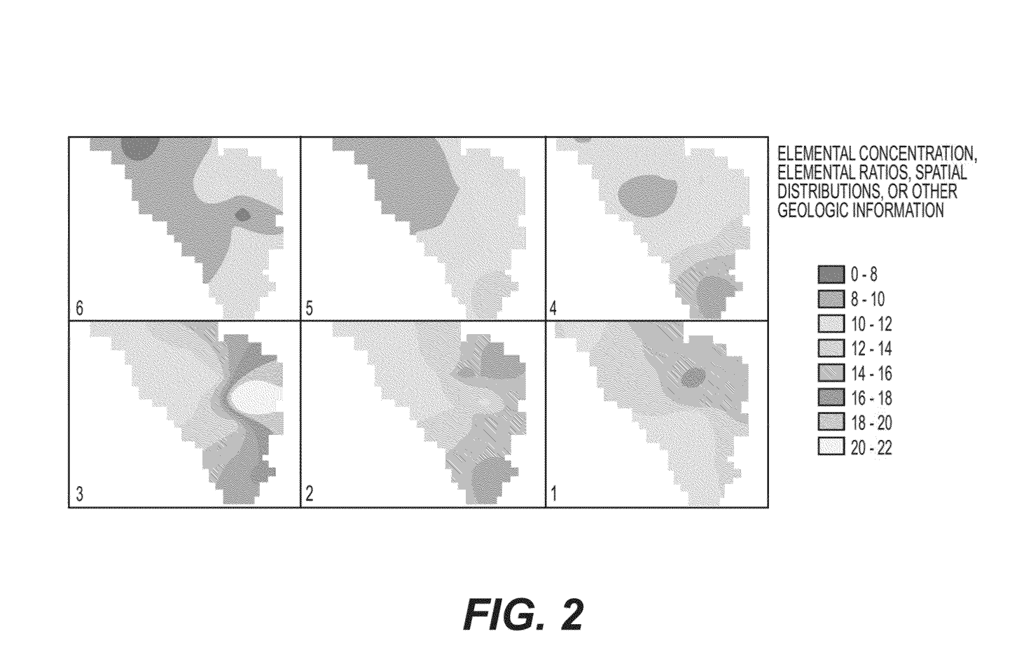

FIG. 2 depicts an example of map-based spatial analysis showing several spatially mapped distributions of elemental concentrations, elemental ratios, or spatial distributions (i.e. depths), or other geologic information, according to an embodiment of the present invention. Other geologic information can include TOC measurements, mineralogy, vitrinite reflectance, and hydrocarbon production. As shown in FIG. 2, the various distributions are defined on geographical maps as contours which can either be outlined as shown by colors or be shown as lines drawn on a geographical map. FIG. 2 may be plotted with map-producing software. Warm colors (reds) represent higher values of elemental concentration, higher values of elemental ratios, or higher values of other geologic information. Cool colors (greens) represent lower values of elemental concentration, lower values of elemental ratios or lower values of other geologic information. Maps 1 through 6 depict the same variable of interest (e.g., a concentration of certain element or an elemental ratio between two given elements) at designated intervals as defined by the framework. These intervals can include, but not limited to, formations, members, sequences, para-sequences, depth intervals, and age or time (e.g., depositional time).

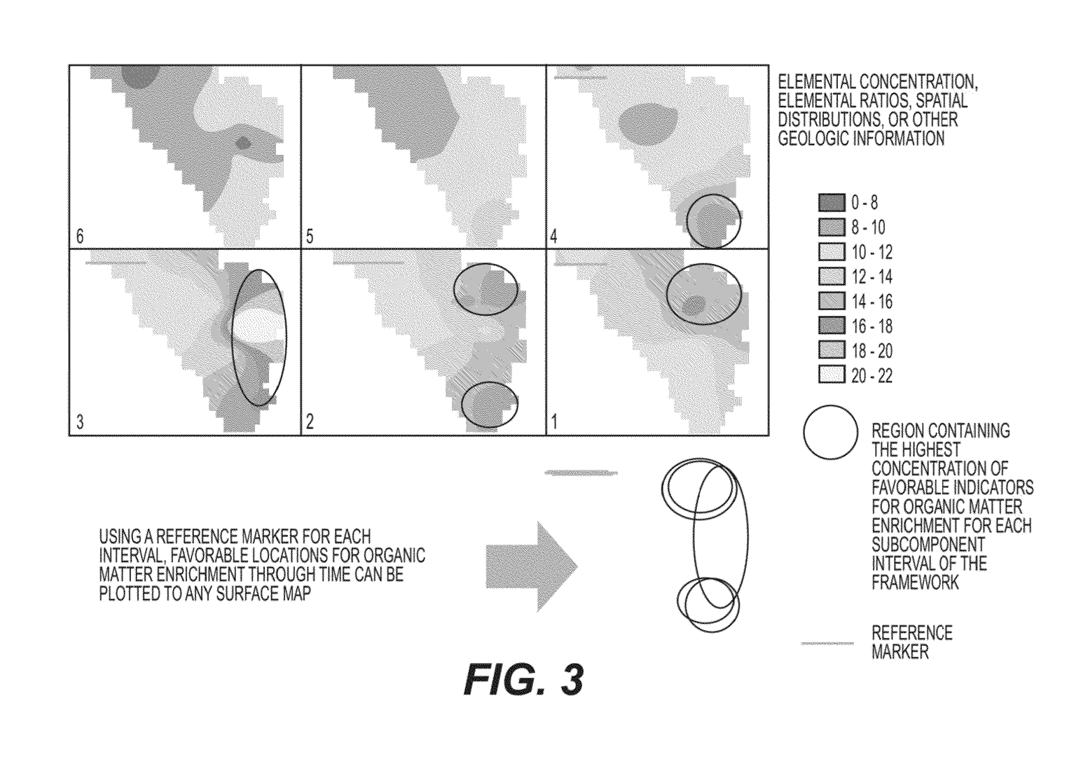

FIG. 3 provides an example of a method of identification of “sweet spot” or identification of best locations for highest potential of finding a hydrocarbon (e.g., an oil or gas) reservoir, according to an embodiment of the present invention. As described above with respect to FIG. 2, elements, elemental ratios, and/or other geologic information or data may be plotted with map-producing software to examine the spatial distribution of relevant environmental indicators. In one embodiment, for example, in order to identify sweet spots, redox indicators may be used. In the example shown in FIG. 3, warm colors are representative of high concentrations of favorable indicators for organic matter enrichment and/or hydrocarbon potential. Using a marker for each time interval of interest 1, 2, 3, 4, 5 and 6 within the framework allows for comparison of favorable locations through time. The ovals indicate locations containing the highest concentration of favorable indicators for organic matter enrichment through time and for each time interval 1, 2, 3, 4, 5 and 6 (e.g., depositional layers 1, 2, 3, 4, 5 and 6).

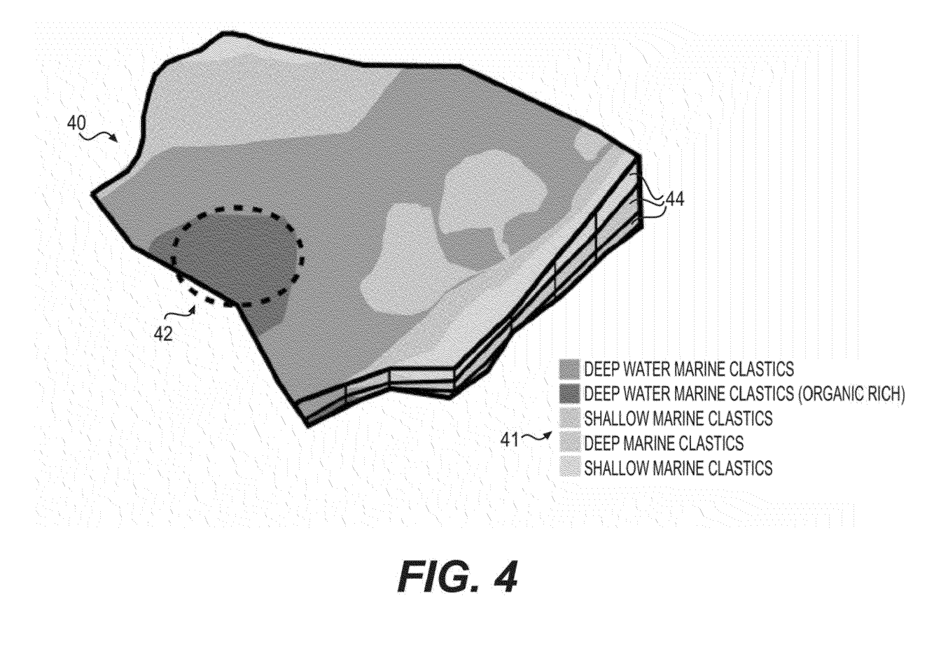

FIG. 4 shows a map rendering 40 of a schematic depositional model, according to an embodiment of the present invention. FIG. 4 illustrates a potential product or a result of a workflow or method described herein. Color key 41 provides color coding for geological features within the depositional model. The light green color indicates the presence of deep water marine clastics, the dark green color indicates the presence of deep water marine clastics that are organic rich, the orange color indicates the presence of shallow marine clastics, and the greenish-yellowish color indicates the presence of deep marine clastics that are mixed with sand and silt. Dotted oval 42 indicates a depositional environment with conditions and lithologies favorable for organic matter accumulation and preservation. The layers 44 indicate horizons of basin model evolution.

The spatial distribution of shallow sediments is an interpretation of paleo-shoreline morphology in the context of the established framework. In other words, the morphology through time. The sediment depocenters and assumed provenance are also interpretations resulting from the elemental and spatial analysis of HHXRF measurements. Although not explicitly illustrated, inherent to the interpreted rates and amounts of siliciclastic influx, is an interpretation of redox conditions during sediment deposition at areas of interest.

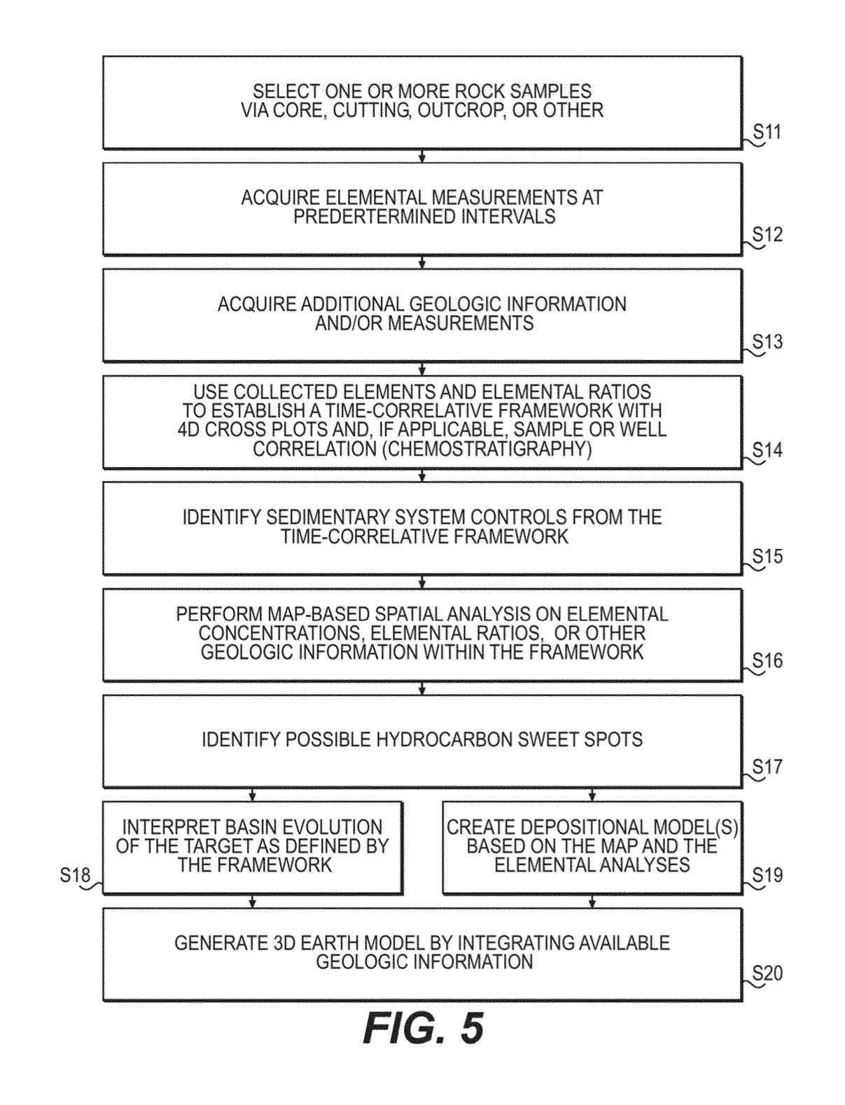

FIG. 5 is a flow chart of a method of identifying hydrocarbon potential in a rock formation, according to an embodiment of the present invention. In one embodiment, the present method provides a regional depositional model and identification of potential sweet spots. In one embodiment, an integral component of the method is to establish a framework in which the elemental measurements may be interpreted for geologic relevance. With this in mind, an initial sampling program can be created allowing sufficient representation of an entire region of interest. For example, the method includes selecting one or more rock samples through, for example, core, cutting, outcrop or other feature, at S11. The method further includes acquiring or collecting elemental measurements at predetermined intervals of time, at S12. For example, HHXRF elemental measurements are collected directly from the rock sample. In one embodiment, the method further includes, acquiring or collecting additional geologic information and/or measurements, at S13. For example, accompanying rock descriptions are acquired by HHXRF. For example, additional rock descriptions may be obtained by visual and physical inspection of the rock medium in natural or artificial light, or both.

Elemental analyses to establish a framework are a function of, but not limited to, regional sample correlation, 4D cross plot analysis, and spatial analysis. Sample correlation includes one or more elements or elemental ratios compared across the region of interest. The method includes establishing a time-correlative framework wherein the framework may be discretized into subcomponents of unique elemental characteristics that represent certain depositional conditions. For example, the time correlative framework can be established using collected elements and/or elemental ratios with 4D cross plots and with sample or well correlation (chemo-stratigraphy), if applicable, at S14. An example of the four-dimensional (4D) cross plot analysis is shown in FIG. 1. The cross plot analysis involves determining a plot of a concentration of a first element or first elemental ratio versus a concentration of a second element or second elemental ratio in the plurality of elements or plurality of elemental ratios. Elemental concentrations are plotted in reference to the established framework and are therefore, interpreted within the context of time and space. The method further includes identifying sedimentary system controls from the time-correlative framework, at S15. For example, this may include filtering relative to a threshold concentration of a third element or elemental ratio adds a fourth dimension to the analysis.

Each unique pairing of elemental variables assessed in the 4D cross plot analysis allows for identification of key environmental indicators. For example, based on the constraints set by the framework, regional variations in the elemental signatures for coeval sediments can be classified and quantified. These variations and trends in the elemental pairings allow inferences regarding the paleo-depositional attributes, including, but not limited to, provenance, biogenic sediments, early-diagenetic signatures, detrital sediments, late-stage diagenetic overprinting, and redox conditions at or near the sediment water interface during deposition.

The method may further include performing map-based spatial analysis on elemental concentrations, elemental ratios, or other geologic information within the frame work, at S16. For example, in addition to sample correlations and 4D cross plot analyses, mapping-capable software can be used to assess the spatial distribution of individual elements and identified environmental indicators. As it can be appreciated, information can be interpreted within the context of the established framework to produce viable depositional histories for a region of interest. In one embodiment, it is preferred, but not required, to perform the map-based spatial analysis procedure S16 in conjunction with the correlation and cross plot elemental analyses S14 and S15. The procedures S14, S15 and S16 may be performed contemporaneously or iteratively with one another to provide quality control for interpreted depositional conditions.

When generating maps according to the established framework (for example, the framework shown in FIG. 2), it is possible to qualitatively interpret the temporal evolution of the paleo-shoreline, and as such, gain an understanding of basin evolution as a function of the basin sedimentary history. In one embodiment, the method may further include identifying favorable locations for oil and/or gas accumulations and may be termed “sweet spots”, using spatial distribution of environmental indicators, at S17. The method may further include interpreting basin evolution model or models of the target area as defined by the framework, at S18.

The method may also include creating a depositional model or models based on the map and elemental analyses, at S19. In one embodiment, the quality of the final depositional model, at S19 (an example of which is shown in FIG. 4) may be contingent upon establishing the time-correlative framework at S14, identifying and quantifying the components of the sedimentary system, at S15, and qualitatively interpreting temporal basin evolution, at S16 and S18. These contingencies may be resolved using the information or dataset acquired with an HHXRF device and the application of the workflow shown in FIG. 5. By supplementing the depositional model with all relevant and attainable geologic information, an all-encompassing 3D earth model can be generated over the region of interest, at S20.

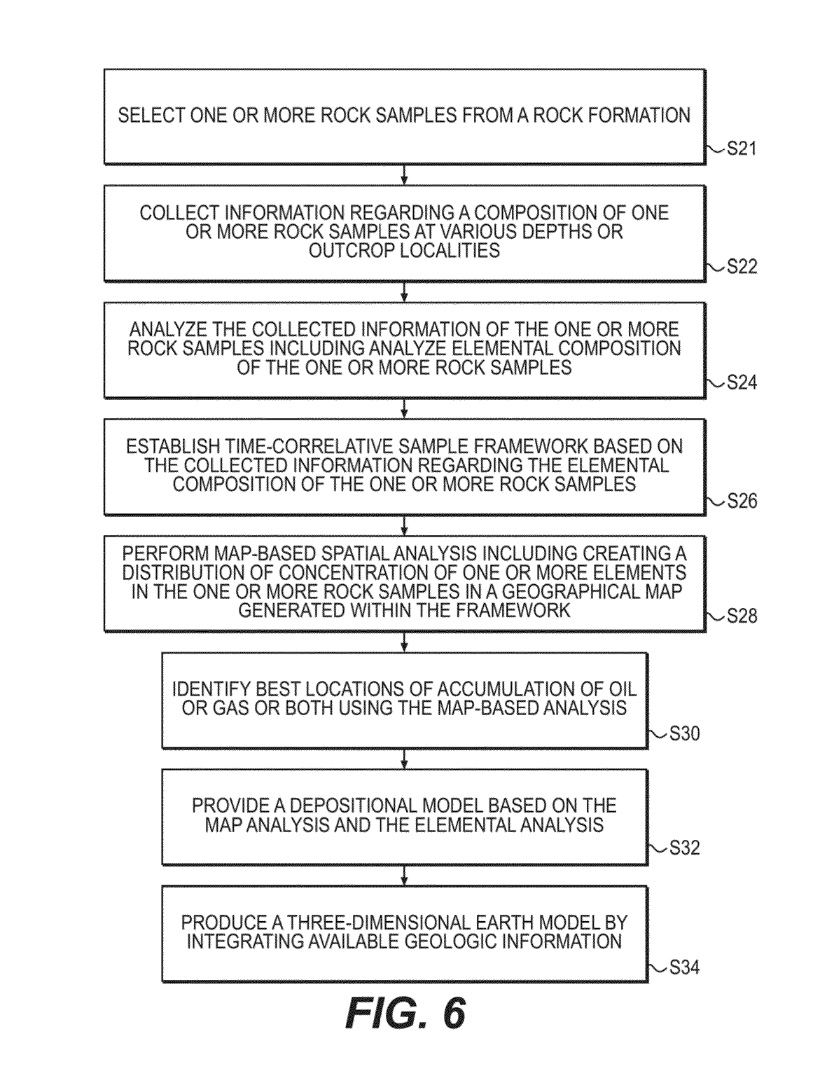

FIG. 6 is another flow chart of the method of identifying hydrocarbon potential in a rock formation, according to an embodiment of the present invention. As it can be appreciated from the above paragraphs, in one embodiment, the method includes selecting one or more samples or medium from the rock formation, at S21 (also described above with respect to FIG. 5 at S11). The one or more samples can be, for example, one or more cores extracted from a rock formation at one or more wells. The method further includes acquiring or collecting information or a dataset about the one or more samples extracted from one or more rock formations, at S22 (also described above with respect to FIG. 5 at S12). The acquiring can include acquisition of HHXRF measurements about the one or more samples (e.g., HHXRF measurements from the one or more cores) and optionally describing the one or more samples such as through a visual inspection of the lithology in one or more samples under natural light or artificial light, or both. For example, the one or more samples can be visually inspected and analyzed by a geologist by illuminating the sample with visible light or ultraviolet light to describe the lithology or rock structure (e.g. deposition layers) within the rock sample. The acquiring may further include obtaining geophysical, petrophysical and/or other geological data or information from one or more outside sources (i.e., data other than the data or information measured directly via XRF from the analyzed sample). For example, additional geophysical, petrophysical and/or other geological information or data from previous work performed in the area where the rock samples are extracted may be used. In addition, other geophysical, petrophysical and/or other geological information or data may also be gleaned from published literature if the published information or data pertains to the area of interest where the rock samples are extracted. The method further includes analyzing the collected information regarding the composition of the one or more samples including analyzing the HHXRF measurements, at S24 (also described above with respect to FIG. 5 at S14 through S16). In one embodiment, the analyzing includes performing an elemental analysis (i.e., analysis of a plurality of elements). In one embodiment, the elemental analysis includes determining a concentration or content of various elements and may include TOC, or any combination thereof versus sample depth and/or locality. The elemental analysis may further include determining elemental ratios versus sample depths and/or localities. In one embodiment, the determining of the concentration of various elements can be performed for a plurality of geographically spaced samples, outcrops, or wells.

The method further comprises determining various framework variables, which may include information regarding the depositional sequences, based on the collected information or dataset regarding the compositions of the one or more samples at S26 (also described above with respect to FIG. 5 at S14-S16). The established framework reflects the time dimension. In one embodiment, the framework can be identified by interpolating the elemental measurements (obtained by using HHXRF, for example) between the plurality of locations (e.g., wells, or others) and subsequently, a geological cross section can be constructed. For example, a sedimentary package may be relatively thick at one location, but thinner, or perhaps, nonexistent at another location. These changes in thickness and or presence are important for establishing the framework as well as identifying changes in depositional environment.

In one embodiment, the elemental analysis further includes performing a 4-dimensional (4D) cross plot analysis of a concentration of a first element versus a concentration of a second element in the plurality of elements, elemental ratios or other geologic information for one or more framework-defined depositional packages with or without filtering relative to a threshold concentration of a third element and color coded according to the framework, as shown, for example, in FIG. 1. Although the plotted points are shown as color-coded, it can be appreciated that any other type of coding can be used. For example, the plotted points can be varied in shape or size such that a different point shape can be used to differentiate between the sequences or between the geographical areas of interest, etc.

In another embodiment, the 4D plot analysis includes determining a plot of a concentration of a first element or first elemental ratio versus a concentration of a second element or second elemental ratio for various geographical areas of interest (NE, SW, etc.), i.e., perform a spatial analysis, with or without filtering relative to a threshold concentration of a third element, as depicted in FIG. 2 and FIG. 3.

Therefore, as it can be appreciated, the four dimensions or the 4 variables in the 4D cross plot analysis are two elemental concentrations or ratios, a framework context representing “time” and/or location, and elemental threshold concentration. For example, the first element could be silicon (Si) concentration, the second element could be aluminum (Al) concentration, the third element could be molybdenum (Mo) concentration, and the fourth dimension could be total organic carbon concentration (TOC) with all the previous variables filtered to a specific geographic area of interest. It is worth noting that any of the four aspects mentioned above for the 4D analysis can be, but not limited to, elemental concentrations, elemental ratios, or other geologic information or dataset (TOC, XRD, etc).

In the above elemental analysis, an initial sedimentary depositional model is created based on a constraint of the sedimentary system that is known. A sample correlation and cross plot analysis and optionally a spatial analysis can then be performed at S28 (also described at S14-S16 with respect to FIG. 5) based on the collected HHXRF measurements or dataset, etc. Certain elemental signatures that behave as proxies for environmental conditions (redox, organic matter enrichment, etc.) are identified based on the 4D cross plot analysis and optionally the spatial analysis. If these elemental signatures that behave as proxies of environmental conditions do not match the constraints, the approach of sample-correlation, 4D cross plot analysis, and sometimes, spatial analysis is reiterated using trial and error to discover which elemental arrangements are significant.

In one embodiment, the workflow further includes performing a map-based spatial analysis, at S28 (also described at S16 with respect to FIG. 5). In one embodiment, ArcGIS or equivalent software can be used to create distribution models or maps of concentration of key elements (example: Si, Al, Si, Mo, etc.) and/or distribution ratios of elements that were identified in the elemental analysis. Examples of distribution maps are provided in FIG. 2. The distribution maps allow approximate paleoshoreline morphologies at each sequence or interval in time. The observation can then be tied back to sample correlations and the framework to understand fluctuations in sea level with time and the impact on the environment such as redox or organic matter accumulation and preservation. By integrating the geologic information, changes in basin morphology can be interpreted in the context of tectonic history. The tectonic basin evolution and spatial understanding of depositional environment allows creation of a Basin Evolution Model. Spatial distribution of environmental indicators can also be used to identify best locations (“sweet spots”) for oil or gas accumulation or reservoir. In one embodiment, the procedures described above with respect to FIG. 3, can be used to identify the “sweet spots”, at S30 (also described above with respect to FIG. 5 at S17). This method can be used to locate areas with relatively high concentrations of key indicators of hydrocarbon potential for each sedimentological and/or time interval within the framework. Overlapping the map-products with respect to key indicators for each interval allows examination of sweet spot formation and migration with time.

The method further includes, providing a depositional model based on the elemental analysis and the map analysis, at S32 (also described in above with respect to FIG. 5 at S19). The depositional model includes integrating the understanding of the sedimentary system and basin evolution, illustrated in FIG. 4, for example. The workflow further includes integrating all available geologic information with the depositional model to produce an all-encompassing 3D earth model, at S34 (also described above with respect to FIG. 5 at S20).

In one embodiment, the method or methods described above with respect to flowchart of FIG. 5 or the flow chart of FIG. 6 can be implemented as a series of instructions which can be executed by a computer, the computer having one or more processors or computer processor units (CPUs). As it can be appreciated, the term “computer” is used herein to encompass any type of computing system or device including a personal computer (e.g., a desktop computer, a laptop computer, or any other handheld computing device), or a mainframe computer (e.g., an IBM mainframe), or a supercomputer (e.g., a CRAY computer), or a plurality of networked computers in a distributed computing environment.

For example, the method(s) may be implemented as a software program application which can be stored in a computer readable medium such as hard disks, CDROMs, optical disks, DVDs, magnetic optical disks, RAMs, EPROMs, EEPROMs, magnetic or optical cards, flash cards (e.g., a USB flash card), PCMCIA memory cards, smart cards, or other media.

Alternatively, a portion or the whole software program product can be downloaded from a remote computer or server via a network such as the internet, an ATM network, a wide area network (WAN) or a local area network.

Alternatively, instead or in addition to implementing the method as computer program products) (e.g., as software products) embodied in a computer, the method can be implemented as hardware in which for example an application specific integrated circuit (ASIC) can be designed to implement the method.

Various databases can be used which may be, include, or interface to, for example, an Oracle™ relational database sold commercially by Oracle Corporation. Other databases, such as Informix™, DB2 (Database 2) or other data storage, including file-based, or query formats, platforms, or resources such as OLAP (On Line Analytical Processing), SQL (Standard Query Language), a SAN (storage area network), Microsoft Access™ or others may also be used, incorporated, or accessed. The database may comprise one or more such databases that reside in one or more physical devices and in one or more physical locations. The database may store a plurality of types of data and/or files and associated data or file descriptions, administrative information, or any other data.

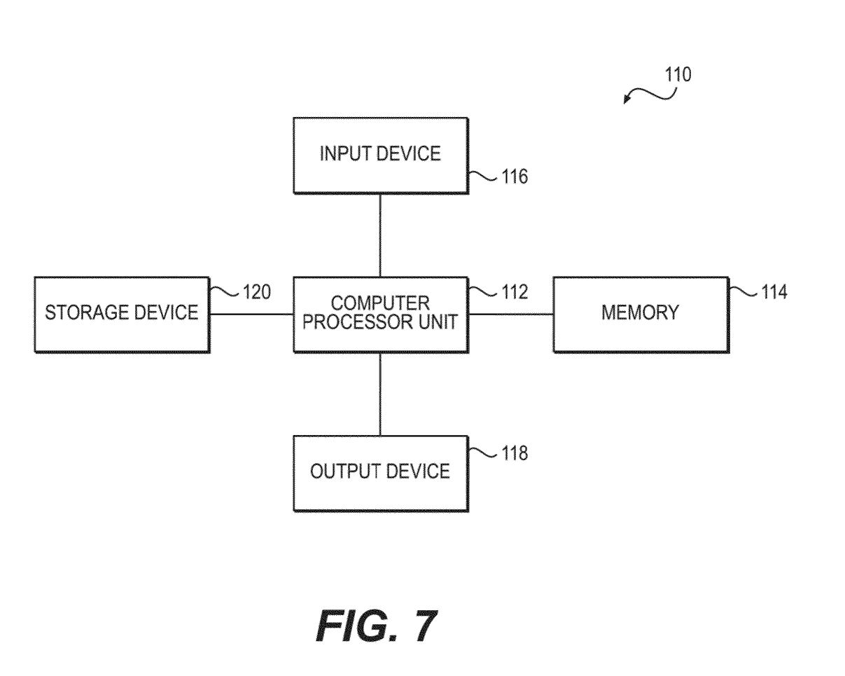

FIG. 7 is a schematic diagram representing a computer system 110 for implementing the methods, according to an embodiment of the present invention. As shown in FIG. 7, computer system 110 comprises a computer processor unit (e.g., one or more computer processor units) 112 and a memory 114 in communication with the processor 112. The computer system 110 may further include an input device 116 for inputting data (such as keyboard, a mouse or the like) and an output device 118 such as a display device for displaying results of the computation. The computer may further include or be in communication with a storage device 120 for storing data such as, but not limited to, a hard-drive, a network attached storage (NAS) device, a storage area network (SAN), etc. It must be appreciated that the term computer processor unit or processor is used herein to encompass one or more computer processor units. Where reference is made to a processor or computer processor unit that term should be understood to encompass any of these computing arrangements.

As it can be appreciated from the above paragraphs, the system 110 is provided for identifying hydrocarbon sweet spot in a rock formation. The system 110 includes storage device 120 configured to store a dataset comprising an elemental composition of one or more rock samples at a plurality of depths or locations, the dataset being collected using an x-ray fluorescence device; and one or more computer processor units 112 configured to: 1) analyze the collected dataset of the one or more rock samples including analyzing the elemental composition of the one or more rock samples; 2) establish a time-correlative sample framework based on the collected dataset regarding the elemental composition of the one or more rock samples; 3) perform map-based spatial analysis comprising creating a distribution of concentration of one or more elements in the one or more rock samples in a geographical map generated within the framework; and 4) identify one or more locations of accumulation of hydrocarbons using the map-based analysis.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

Furthermore, since numerous modifications and changes will readily occur to those of skill in the art, it is not desired to limit the invention to the exact construction and operation described herein. Accordingly, all suitable modifications and equivalents should be considered as falling within the spirit and scope of the invention.

What is claimed is:

1. A method for identifying a hydrocarbon sweet spot in a rock formation, comprising:
collecting a dataset comprising an elemental composition of one or more rock samples at a plurality of depths or locations, using an x-ray fluorescence device;
analyzing the collected dataset of the one or more rock samples including analyzing the elemental composition of the one or more rock samples;
establishing a time-correlative sample framework based on the collected dataset regarding the elemental composition of the one or more rock samples;
performing a map-based spatial analysis comprising creating a distribution of concentration of one or more elements in the one or more rock samples in a geographical map generated within the framework; and
identifying one or more locations of accumulation of hydrocarbons using the map-based spatial analysis.

2. The method according to claim 1, wherein the one or more rock samples comprise rock materials extracted from a surface or a subsurface rock formation or units of interest.

3. The method according to claim 1, wherein collecting the dataset further comprises providing rock sample descriptions through a visual inspection.

4. The method according to claim 1, wherein collecting the dataset further comprises obtaining geophysical, petro-physical or geological information from one or more outside sources.

5. The method according to claim 1, wherein analyzing the collected dataset comprises analyzing x-ray fluorescence measurements of the one or more rock samples.

6. The method according to claim 1, wherein analyzing the elemental composition comprises determining a concentration of one or more elements in the one or more samples.

7. The method according to claim 1, wherein analyzing the elemental composition comprises determining a ratio of concentrations of two or more elements in the one or more rock samples.

8. The method according to claim 1, wherein analyzing the collected dataset regarding the composition of the one or more rock samples comprises analyzing the one or more rock samples distributed spatially throughout a region of interest and collected within the framework.

9. The method according to claim 1, wherein analyzing the elemental composition of the one or more rock samples comprises providing a four-dimensional cross plot including a plot of a concentration of a first element or a first elemental ratio in the one or more rock samples versus a concentration of a second element or a second elemental ratio in the one or more rock samples within the context of the established framework.

10. The method according to claim 9, wherein providing the plot of a concentration of the first element or the first elemental ratio versus the second element or the second elemental ratio within the spatial and temporal framework context comprises one or more elements or elemental ratios or supplementary geologic information at a concentration of a third element or third element ratio or a supplementary geologic information greater than a selected threshold.

11. The method according to claim 1, wherein establishing the framework comprises interpolating elemental measurements from samples extracted from spatially relevant sources of rock material.

12. The method according to claim 1, further comprising providing a depositional model based on the map analysis and the elemental analysis.

13. The method according to claim 12, further comprising producing a three-dimensional earth model by integrating available geologic information with the depositional model.

14. A system for identifying a hydrocarbon sweet spot in a rock formation, the system comprising:
an x-ray fluorescence (XRF) device configured to acquire XRF data from a rock sample;
a storage device configured to store a dataset comprising an elemental composition of one or more rock samples at a plurality of depths or locations, the dataset being collected using the XRF device; and
one or more computer processor units configured to:
analyze the collected dataset of the one or more rock samples including analyzing the elemental composition of the one or more rock samples;
establish a time-correlative sample framework based on the collected dataset regarding the elemental composition of the one or more rock samples;
perform map-based spatial analysis comprising creating a distribution of concentration of one or more elements in the one or more rock samples in a geographical map generated within the framework; and
identify one or more locations of accumulation of hydrocarbons using the map-based analysis.

15. The system according to claim 14, wherein the one or more rock samples are extracted from a surface or a subsurface of the rock formation.

16. The system according to claim 14, wherein the collected dataset further comprises rock sample descriptions through a visual inspection.

17. The system according to claim 14, wherein the collected dataset further comprises geophysical, petro-physical or geological data from one or more outside sources.

18. The system according to claim 14, wherein the one or more computer processor units are configured to analyze x-ray fluorescence measurements of the one or more rock sample.

19. The system according to claim 14, wherein the one or more computer processor units are configured to determine a concentration of one or more elements in the one or more rock samples.

20. The system according to claim 14, wherein the one or more computer processor units are configured to determine a ratio of concentrations of two or more elements detected in the one or more rock samples.

21. The system according to claim 14, wherein the one or more computer processor units are configured to analyze the one or more rock samples distributed spatially throughout a region of interest and collected within the framework.

22. The system according to claim 14, wherein the one or more computer processor units are configured to provide a four-dimensional cross plot including a plot of a concentration of a first element or a first elemental ratio in the one or more rock samples versus a concentration of a second element or a second elemental ratio in the one or more rock samples within the context of the established framework.

23. The system according to claim 14, wherein the one or more computer processor units are configured to interpolate elemental measurements from rock samples extracted from spatially relevant sources of rock material.

24. The system according to claim 14, wherein the one or more computer processor units are configured to provide a depositional model based on the map analysis and the elemental analysis.

25. The system according to claim 14, wherein the one or more computer processor units are configured to produce a three-dimensional earth model by integrating available geologic information with the depositional model.
